(19) United States
(12) Patent Application Publication
(10) Pub. No.: US 2026/0221602 A1
(43) Pub. Date: Jul. 30, 2026

(54) SEPARATOR FOR ELECTROCHEMICAL DEVICE, MATERIAL FOR ELECTROCHEMICAL DEVICE, AND ELECTROCHEMICAL DEVICE

(71) Applicant: SUMITOMO CHEMICAL COMPANY, LIMITED, Tokyo (JP)

(72) Inventor: Taiga ISHII, Niihama-shi (JP)

(21) Appl. No.: 19/389,299

(22) Filed: Nov. 14, 2025

(30) Foreign Application Priority Data
Jan. 28, 2025 (JP) 2025-012381

(51) Int. Cl. H01M 50/489; H01G 11/52; H01M 10/42; H01M 50/423; H01M 50/449

(52) U.S. Cl. CPC H01M 50/489; H01G 11/52; H01M 10/4235; H01M 50/423; H01M 50/449

(57) ABSTRACT

Provided is a separator that is further improved in heat resistance. The separator of the present disclosure includes a porous substrate and a porous layer formed on the porous substrate, and has peel strengths Ta, Tb, and Tc each satisfying at least one of Expression (1) and Expression (2) below, the peel strengths Ta, Tb, and Tc being measured under conditions of a measurement temperature of 120° C. and respective peel speeds of 1 mm/min, 100 mm/min, and 1000 mm/min.

$$Tb / Ta \leq 5. \qquad ( 1 )$$

$$Tc / Ta \leq 15. \qquad ( 2 )$$

This Nonprovisional application claims priority under 35 U.S.C. § 119 on Patent Application No. 2025-012381 filed in Japan on Jan. 28, 2025, the entire contents of which are hereby incorporated by reference.

### TECHNICAL FIELD

The present invention relates to a separator for an electrochemical device (hereinafter referred to as a “separator”), a material for an electrochemical device (hereinafter referred to as a “material”), and an electrochemical device.

### BACKGROUND ART

Electrochemical devices, e.g., nonaqueous electrolyte secondary batteries, particularly lithium ion secondary batteries, have a high energy density, and are therefore widely used as batteries for personal computers, mobile telephones, portable information terminals, cars, and the like.

As a material of such a nonaqueous electrolyte secondary battery, a separator having excellent heat resistance is under development. For example, as in Patent Literature 1, a separator is known in which a porous layer that is a heat-resistant layer containing an aramid resin and inorganic particles is formed on a porous substrate.

### CITATION LIST

### Patent Literature

### [Patent Literature 1]

International Publication No. WO 2019/176421

### SUMMARY OF INVENTION

### Technical Problem

However, the conventional separator, in which a porous layer is formed on a porous substrate, has room for improvement in terms of further enhancing heat resistance.

An aspect of the present invention has an object to provide a separator that is further improved in heat resistance.

### Solution to Problem

A separator in accordance with an aspect of the present invention includes: a porous substrate; and a porous layer formed on at least one surface of the porous substrate,
the separator satisfying Expression (1) and/or Expression (2) below:

$$Tb / Ta \leq 5. \qquad ( 1 )$$

$$Tc / Ta \leq 15. \qquad ( 2 )$$

where Ta, Tb, and Tc represent respective peel strengths obtained as a result of performing peel tests on the separator under conditions of peel speeds of 1 mm/min, 100 mm/min, and 1000 mm/min, each of the peel tests being performed under a condition of a measurement temperature of 120° C. by a method in conformity with JIS K 6854-3.

### Advantageous Effects of Invention

An aspect of the present invention makes it possible to provide a separator that is further improved in heat resistance.

### BRIEF DESCRIPTION OF DRAWINGS

FIG. 1 is a model representing a mode of resistance to applied force in a peel test conducted on a separator in which (i) a porous substrate has a sufficient strength in comparison to a porous layer and (ii) the porous layer and the porous substrate are firmly adhered to each other at an interface therebetween.

FIG. 2 is a model representing a mode of resistance to applied force in a peel test conducted on a separator in which (i) a porous layer has a sufficient strength in comparison to a porous substrate and (ii) the porous layer and the porous substrate are firmly adhered to each other at an interface therebetween.

FIG. 3 is a model representing a mode of resistance to applied force in a peel test conducted on a separator in which (i) a porous substrate has a sufficient strength in comparison to a porous layer and (ii) the porous layer and the porous substrate are not firmly adhered to each other at an interface therebetween.

### DESCRIPTION OF EMBODIMENTS

The following description will discuss embodiments of the present invention. Note, however, that the present invention is not limited to the embodiments. Any numerical range expressed as “A to B” herein means “not less than A and not more than B” unless otherwise stated.

### [1. Separator]

A separator in accordance with an embodiment of the present invention includes: a porous substrate; and a porous layer formed on at least one surface of the porous substrate, the separator satisfying Expression (1) and/or Expression (2) below:

$$Tb / Ta \leq 5. \qquad ( 1 )$$

$$Tc / Ta \leq 15. \qquad ( 2 )$$

where Ta, Tb, and Tc represent respective peel strengths obtained as a result of performing peel tests on the separator under conditions of peel speeds of 1 mm/min, 100 mm/min, and 1000 mm/min, each of the peel tests being performed under a condition of a measurement temperature of 120° C. by a method in conformity with JIS K 6854-3.

Hereinafter, the separator in accordance with an embodiment of the present invention is also referred to as “the present separator”. Hereinafter, a separator that, like the present separator, includes a porous substrate and a porous layer formed on at least one surface of the porous substrate is also referred to as “laminated separator”.

### Mechanism in Accordance with an Embodiment of the Present Invention

Hereinafter, the peel test in accordance with an embodiment of the present invention is referred to as “the present peel test”. The inventors of the present invention have found that, in the present peel test, a peel strength that reflects the magnitudes of elastic resistance and viscous resistance of the porous layer can be stably measured. Furthermore, the inventors of the present invention have discovered that, since the peel strength of the present separator measured in the present peel test satisfies Expression (1) and/or Expression (2), the present separator achieves the effect of being further improved in heat resistance. The above effect of the present separator can be presumed to be achieved through the following mechanism.

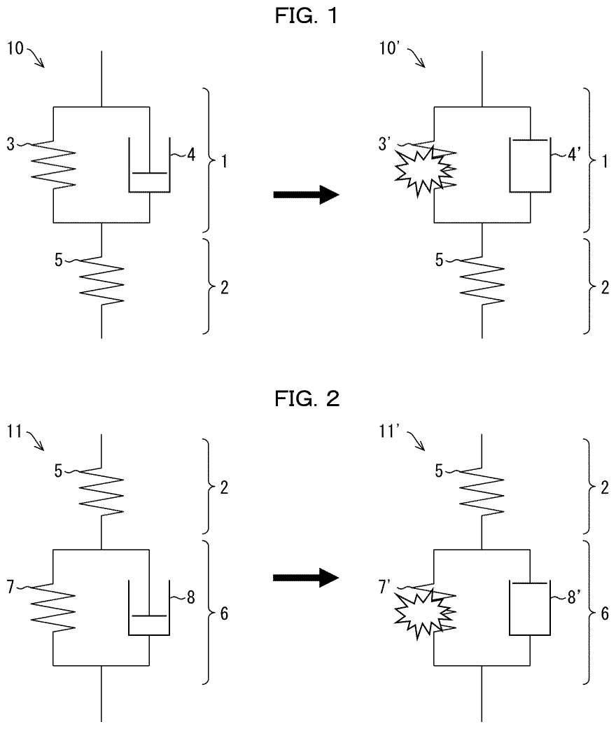

An aspect of a laminated separator may be such that: the laminated separator includes a porous substrate and a porous layer formed on at least one surface of the porous substrate; the porous substrate has a sufficient strength in comparison to the porous layer; and the porous layer and the porous substrate are firmly adhered to each other at an interface therebetween. Hereinafter, the laminated separator in accordance with the above aspect is also referred to as “laminated separator A”. FIG. 1 is a model representing a mode of resistance to applied force in each of the following tests conducted on a separator corresponding to the laminated separator A: a peel test conducted under conditions of normal temperature and an extremely low peeling speed; and the peel test in accordance with an embodiment of the present invention.

In a peel test conducted on a laminated separator, a resistance to applied force is generated in the porous substrate itself, in the porous layer itself, and at an interface between the porous layer and the porous substrate. In the laminated separator A, the porous layer has lower strength than the porous substrate and is more prone to breakage. As such, in the peel tests, the laminated separator A undergoes a breakage of the porous layer when the force exceeds the resistance generated within the porous layer itself, or undergoes a breakage of the interface when the force exceeds the resistance generated at the interface. As a result, the porous layer is peeled off from the porous substrate in the peel tests conducted on the laminated separator A.

When a peel test is conducted on the laminated separator A under conditions of normal temperature and peeling speeds similar to those of the present peel test, a resistance generated at the interface is smaller than a resistance generated within the porous layer itself. As a result, the interface rather than the porous layer breaks, and the porous layer peels off from the porous substrate. As such, in the peel test conducted on the laminated separator A under the conditions of normal temperature and the peeling speeds similar to those of the present peel test, it is not possible to measure a peeling strength that reflects the magnitudes of elastic resistance and viscous resistance of the porous layer.

Note here that, as indicated by a model 10 illustrated in FIG. 1 which represents a mode of resistance in the laminated separator in the peel tests, in the peel tests conducted on the laminated separator A, an elastic resistance 3 and a viscous resistance 4 are generated in a porous layer 1 in response to the force, and an elastic resistance 5 is generated at the interface 2 in response to the force. It is known that an elastic resistance in a peel test remains constant regardless of a peeling speed. Therefore, during the peel tests on the laminated separator A, the elastic resistance 3 of the porous layer 1 and the elastic resistance 5 of the interface 2 remain constant regardless of a peeling speed. In general, a viscous resistance q is expressed by Expression (3) below.

$$Viscous resistance q = μ \frac{du}{dy} \qquad ( 3 )$$

In Expression (3), μ represents a viscosity coefficient, which is a constant specific to the object, and (du/dy) corresponds to a peeling speed. As the peeling speed increases, the value of (du/dy) increases, so that the viscous resistance q increases. Therefore, during the peel tests conducted on the laminated separator, the viscous resistance 4 of the porous layer 1 varies depending on the peeling speed and increases when the peeling speed increases.

From the foregoing, when a peel test is conducted on the laminated separator A under conditions of normal temperature and an extremely low peeling speed, which is significantly lower than the peeling speeds in the present peel test, the viscous resistance 4 of the porous layer 1 decreases. This causes the resistance generated within the porous layer itself to be smaller than the resistance generated at the interface. As a result, as shown in a model 10′ in FIG. 1, which represents a mode of resistance of the laminated separator in a state where the porous layer has broken after the peel tests, the porous layer 1 rather than the interface breaks, and the porous layer 1 peels off from the porous substrate. Thus, the peeling strength obtained in the peel test conducted on the laminated separator A under conditions of normal temperature and an extremely low peeling speed reflects the magnitude of a resistance (the viscous resistance 4 etc.) of the porous layer 1.

However, when the peeling speed is adjusted, an error may occur. In the peel test conducted under the conditions of normal temperature and an extremely low peeling speed, the proportion of a variation caused by such an error relative to the peeling strength itself is large, so that the variation significantly affects the measured peeling strength. This results in instability of the measurement results. Therefore, in the peel test conducted under the conditions of normal temperature and an extremely low peeling speed, it is not possible to stably measure a peeling strength that reflects the magnitudes of elastic resistance and viscous resistance of the porous layer.

Incidentally, the porous layer 1 corresponds to a viscoelastic object. It can be understood that, in a viscoelastic object, from the time-temperature superposition principle, a resistance to applied force (i.e., stress generated due to deformation caused by the applied force) is approximately the same between cases (A) and (B) below. Note that the present peel test corresponds to the case (B) below, since it is conducted at a high temperature of 120° C.
(A) A case in which a predetermined displacement is caused at normal temperature and with an extremely low peeling speed (i.e., over a long period of time).
(B) A case in which a predetermined displacement is caused at a high temperature and with a peeling speed higher than the extremely low peeling speed (i.e., over a short period of time).

Therefore, a resistance of the porous layer generated in the present peel test is approximately the same as a resistance of the porous layer in the peel test conducted under the conditions of normal temperature and an extremely low peeling speed (i.e., the case (A)). Accordingly, also in the present peel test that is conducted on the laminated separator A, the porous layer 1 rather than the interface breaks and the porous layer 1 peels off from the porous substrate, as shown in the model 10′ in FIG. 1 which represents a mode of resistance of the laminated separator in a state where the porous layer has broken after the peel tests. Thus, a peeling strength obtained in the present peel test that is conducted on the laminated separator A also reflects the magnitude of a resistance of the porous layer 1. Moreover, since the peeling speeds in the present peel test are higher than the extremely low peeling speed, the proportion of a variation caused by the above-described adjustment error relative to the peeling strength itself is small, so that the variation has a minor effect on the measured peeling strength. Thus, in the present peel test that is conducted on the laminated separator A, it is possible to stably measure the peel strength that reflects the magnitudes of elastic resistance and viscous resistance of the porous layer.

Since the elastic resistance remains constant as described above, in the present peel test that is conducted on the laminated separator A, a difference between Tb and Ta and a difference between Tc and Ta are each attributed to an increase in the viscous resistance 4 of the porous layer 1 caused by an increase in the peeling speed. As such, Tb/Ta and Tc/Ta each serve as an indicator representing a degree of increase in the viscous resistance 4 of the porous layer 1 caused by an increase in the peeling speed. Referring to Expression (3), it can be understood that when a viscosity coefficient is small, an increase in viscous resistance, which increase is caused by an increase in peeling speed by a certain amount, is small. As such, in the present peel test that is conducted on the laminated separator A, Tb/Ta and Tc/Ta each depend on the magnitude of a viscosity coefficient of the porous layer 1. Small values of Tb/Ta and Tc/Ta mean that the viscosity coefficient of the porous layer 1 is also small.

From the above, the present separator that corresponds to the laminated separator A satisfies Expression (1) and/or Expression (2) and therefore has a small viscosity coefficient of the porous layer included in the present separator. Note here that when the porous layer undergoes deformation due to external force, an inside of the porous layer also undergoes a change to generate a strain. To counteract this strain, resistance to the deformation is generated. The inside of the porous layer with the low viscosity coefficient has low viscosity and easily undergoes a change. As such, a strain is easily generated even when the deformation due to the external force is small. As such, the resistance is generated even at a stage where the deformation due to external force is small. In other words, in the porous layer with the low viscosity coefficient μ, resisting force against deformation caused by external force is generated early.

Note here that, under high temperature conditions, a separator that includes a porous substrate and a porous layer formed on at least one surface of the porous substrate initially undergoes thermal shrinkage of the porous substrate, and external force caused by the thermal shrinkage is applied to the porous layer. As a result, deformation occurs in the separator. However, in the present separator that corresponds to the laminated separator A, the above-described deformation is prevented or reduced because resisting force of the porous layer against the external force is generated early. As a result, the present separator that corresponds to the laminated separator A achieves the effect of having a further reduced thermal shrinkage rate.

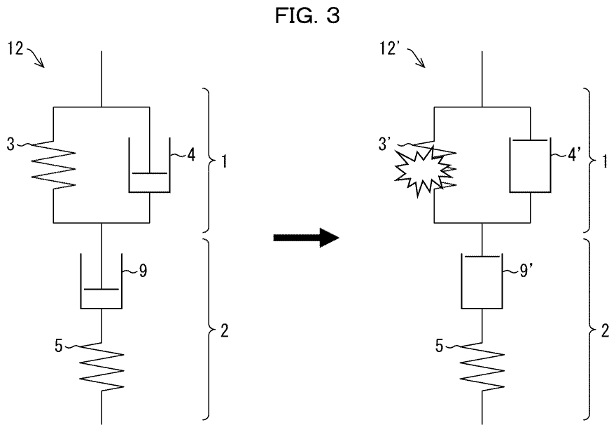

An aspect of a laminated separator may also be such that: the laminated separator includes a porous substrate and a porous layer formed on at least one surface of the porous substrate; the porous layer has a sufficient strength in comparison to the porous substrate; and the porous layer and the porous substrate are firmly adhered to each other at an interface therebetween. Hereinafter, the laminated separator in accordance with the above aspect is also referred to as “laminated separator B”. FIG. 2 is a model representing a mode of resistance to applied force in each of the following tests conducted on a separator corresponding to the laminated separator B: a peel test conducted under conditions of normal temperature and an extremely low peeling speed; and the peel test in accordance with an embodiment of the present invention.

In the laminated separator B, the porous substrate has lower strength than the porous layer and is more prone to breakage. As such, in the peel tests, the laminated separator B undergoes a breakage of the porous substrate when the applied force exceeds the resistance generated within the porous substrate itself, or undergoes a breakage of the interface when the force exceeds the resistance generated at the interface. As a result, the porous layer is peeled off from the porous substrate in the peel tests conducted on the laminated separator B.

When a peel test is conducted on the laminated separator B under conditions of normal temperature and peeling speeds similar to those of the present peel test, a resistance generated at the interface is smaller than a resistance generated within the porous substrate itself. As such, as with conducting the peel tests on the laminated separator A, in the peel test conducted on the laminated separator B under the conditions of normal temperature and the peeling speeds similar to those of the present peel test, it is not possible to measure a peeling strength that reflects the magnitudes of elastic resistance and viscous resistance of the porous substrate.

Note here that, as indicated by a model 11 illustrated in FIG. 2 which represents a mode of resistance in the laminated separator in the peel tests, in the peel tests conducted on the laminated separator B, an elastic resistance 7 and a viscous resistance 8 are generated in a porous substrate 6 in response to the force, and an elastic resistance 5 is generated at the interface 2 in response to the force. Note here that, since an elastic resistance in a peel test remains constant regardless of a peeling speed as described above, during the peel tests on the laminated separator B, the elastic resistance 7 of the porous substrate 6 and the elastic resistance 5 of the interface 2 remain constant regardless of a peeling speed. Further, similarly as the viscous resistance of the porous layer, the viscous resistance 8 of the porous substrate 6 varies depending on the peeling speed and increases when the peeling speed increases.

From the foregoing, when a peel test is conducted on the laminated separator B under conditions of normal temperature and an extremely low peeling speed, the viscous resistance 8 of the porous substrate 6 decreases, so that a resistance generated within the porous substrate itself is smaller than a resistance generated at the interface. As a result, as shown in a model 11′ in FIG. 2, which represents a mode of resistance of the laminated separator in a state where the porous substrate has broken after the peel tests, the porous substrate 6 rather than the interface breaks, and the porous layer peels off from the porous substrate 6. Thus, the peeling strength obtained in the peel test conducted on the laminated separator B under conditions of normal temperature and an extremely low peeling speed reflects the magnitude of a resistance (the viscous resistance 8 etc.) of the porous substrate 6.

Further, the porous substrate 6 corresponds to a viscoelastic object as with the porous layer. As such, the time-temperature superposition principle applies to the porous substrate 6. Accordingly, as with conducting the present peel test on the laminated separator A, also in the present peel test that is conducted on the laminated separator B, the porous substrate 6 rather than the interface breaks and the porous layer peels off from the porous substrate 6, as shown in the model 11′ in FIG. 2 which represents a mode of resistance of the laminated separator in a state where the porous substrate has broken after the peel tests. Thus, a peeling strength obtained in the present peel test conducted on the laminated separator B also reflects the magnitude of a resistance of the porous substrate 6. Moreover, as described above, in the present peel test, the proportion of a variation caused by an error that can occur at the time of adjustment of the peeling speed is small relative to the peeling strength itself, so that the variation has a minor effect on the measured peeling strength. Thus, in the present peel test that is conducted on the laminated separator B, it is possible to stably measure the peel strength that reflects the magnitudes of elastic resistance and viscous resistance of the porous substrate.

Further, for the same reason as in the present peel test that is conducted on the laminated separator A, in the present peel test that is conducted on the laminated separator B, Tb/Ta and Tc/Ta each depend on the magnitude of a viscosity coefficient of the porous substrate 6, and small values of Tb/Ta and Tc/Ta mean that the viscosity coefficient of the porous substrate 6 is also small.

Note here that, under high temperature conditions, a separator that includes a porous substrate and a porous layer formed on at least one surface of the porous substrate initially undergoes thermal shrinkage of the porous substrate, and the porous layer also shrinks, accordingly. Further, thermal shrinkage can also occur in the porous layer. External force caused by these shrinkages of the porous layer is applied to the porous substrate. As a result, deformation occurs in the separator. However, in the present separator that corresponds to the laminated separator B, the above-described deformation is prevented or reduced because resisting force of the porous substrate against the external force is generated early. As a result, the present separator that corresponds to the laminated separator B achieves the effect of having a further reduced thermal shrinkage rate.

An aspect of a laminated separator may also be such that: the laminated separator includes a porous substrate and a porous layer formed on at least one surface of the porous substrate; the porous substrate has a sufficient strength in comparison to the porous layer; and the porous layer and the porous substrate are not firmly adhered to each other at an interface therebetween. Hereinafter, the laminated separator in accordance with the above aspect is also referred to as “laminated separator C”. FIG. 3 is a model representing a mode of resistance to applied force in each of the following tests conducted on a separator corresponding to the laminated separator C: a peel test conducted under conditions of normal temperature and an extremely low peeling speed; and the peel test in accordance with an embodiment of the present invention.

In the peel tests conducted on the laminated separator C, as in the laminated separator A, the porous layer breaks when the applied force exceeds the resistance generated within the porous layer itself, or the interface breaks when the force exceeds the resistance generated at the interface. As a result, the porous layer is peeled off from the porous substrate in the peel tests conducted on the laminated separator C.

When conducting a peel test on the laminated separator C under the conditions of normal temperature and the peeling speeds similar to those of the present peel test, it is not possible to measure a peeling strength that reflects the magnitudes of elastic resistance and viscous resistance of the porous layer, as with the laminated separator A.

Note here that, as indicated by a model 12 illustrated in FIG. 3 which represents a mode of resistance in the laminated separator in the peel tests, in the peel tests conducted on the laminated separator C, an elastic resistance 3 and a viscous resistance 4 are generated in a porous layer 1 in response to the force, and an elastic resistance 5 and a viscous resistance 9 are generated at the interface 2 in response to the force. Note here that, since an elastic resistance in a peel test remains constant regardless of a peeling speed as described above, during the peel tests on the laminated separator C, the elastic resistance 3 of the porous layer 1 and the elastic resistance 5 of the interface 2 remain constant regardless of a peeling speed. Further, the viscous resistance 4 of the porous layer 1 varies depending on the peeling speed and increases when the peeling speed increases. Further, similarly as the viscous resistance of the porous layer, the viscous resistance 9 of the interface 2 increases when the peeling speed increases.

From the foregoing, when a peel test is conducted on the laminated separator C under conditions of normal temperature and an extremely low peeling speed, which is significantly lower than the peeling speeds in the present peel test, the viscous resistance 4 of the porous layer 1 and the viscous resistance 9 of the interface 2 decrease. Note here that, as indicated by the model 12 illustrated in FIG. 3 which represents a mode of resistance in the laminated separator in the peel tests, in the peel tests conducted on the laminated separator C, a resistance generated in the porous layer 1 is represented by a model in which the elastic resistance 3 and the viscous resistance 4 are arranged in parallel. A resistance generated at the interface 2 is represented by a model in which the elastic resistance 5 and the viscous resistance 9 are arranged in series. It is known that a resistance represented by a model in which an elastic resistance and a viscous resistance are arranged in parallel exhibits a greater change in the overall resistance when the viscous resistance undergoes a certain degree of change, compared to a resistance represented by a model in which an elastic resistance and a viscous resistance are arranged in series. As such, when a peel test is conducted on the laminated separator C under conditions of normal temperature and an extremely low peeling speed, the resistance of the porous layer 1 decreases more significantly, so that a resistance generated within the porous layer itself is smaller than a resistance generated at the interface. As a result, as shown in a model 12′ in FIG. 3, which represents a mode of resistance of the laminated separator in a state where the porous layer has broken after the peel tests, the porous layer 1 rather than the interface breaks, and the porous layer 1 peels off from the porous substrate. Thus, the peeling strength obtained in the peel test conducted on the laminated separator C under conditions of normal temperature and an extremely low peeling speed reflects the magnitude of a resistance (the viscous resistance 4 etc.) of the porous layer 1.

Further, as with conducting the present peel test on the laminated separator A, also in the present peel test that is conducted on the laminated separator C, the porous layer 1 rather than the interface breaks and the porous layer 1 peels off from the porous substrate. Thus, a peeling strength obtained in the present peel test that is conducted on the laminated separator C also reflects the magnitude of a resistance of the porous layer 1. Moreover, as described above, in the present peel test, the proportion of a variation caused by an error that can occur at the time of adjustment of the peeling speed is small relative to the peeling strength itself, so that the variation has a minor effect on the measured peeling strength. Thus, in the present peel test that is conducted on the laminated separator C, it is possible to stably measure the peel strength that reflects the magnitudes of elastic resistance and viscous resistance of the porous layer.

Further, for the same reason as in the present peel test that is conducted on the laminated separator A, in the present peel test that is conducted on the laminated separator C, Tb/Ta and Tc/Ta each depend on the magnitude of a viscosity coefficient of the porous layer 1, and small values of Tb/Ta and Tc/Ta mean that the viscosity coefficient of the porous layer 1 is also small. Therefore, the present separator that corresponds to the laminated separator C also achieves the effect of having a further reduced thermal shrinkage rate.

An aspect of a laminated separator may also be such that: the laminated separator includes a porous substrate and a porous layer formed on at least one surface of the porous substrate; the porous layer has a sufficient strength in comparison to the porous substrate; and the porous layer and the porous substrate are not firmly adhered to each other at an interface therebetween. Hereinafter, the laminated separator in accordance with the above aspect is also referred to as “laminated separator D”.

For the same reason as in the peel test conducted on the laminated separator C under conditions of normal temperature and an extremely low peeling speed, the peeling strength obtained in the peel test conducted on the laminated separator D under conditions of normal temperature and an extremely low peeling speed reflects the magnitude of a resistance (viscous resistance etc.) of the porous substrate. Further, for the same reason as in the present peel test that is conducted on the laminated separator B, in the present peel test that is conducted on the laminated separator D, it is possible to stably measure the peel strength that reflects the magnitudes of elastic resistance and viscous resistance of the porous substrate. Further, in the present peel test that is conducted on the laminated separator D, Tb/Ta and Tc/Ta each depend on the magnitude of a viscosity coefficient of the porous substrate, and small values of Tb/Ta and Tc/Ta mean that the viscosity coefficient of the porous substrate is also small. Therefore, as with the present separator that corresponds to the laminated separator B, the present separator that corresponds to the laminated separator D also achieves the effect of having a further reduced thermal shrinkage rate.

The present separator has the aspect of the laminated separator A, B, C, or D. As such, the present separator achieves the effect of having a further reduced thermal shrinkage rate.

It is preferable that the present separator have a small Tb/Ta value, from the perspective of allowing the above-described resisting force to be generated earlier and enabling further reduction of the thermal shrinkage rate. From the above perspective, an upper limit of Tb/Ta is not more than 5.0, preferably not more than 4.5, and more preferably not more than 4.0. A lower limit of Tb/Ta is not particularly restricted and may, for example, be not less than 1.5, preferably not less than 2.0.

Similarly, it is preferable that the present separator have a small Tc/Ta value, from the perspective of allowing the above-described resisting force to be generated earlier and enabling further reduction of the thermal shrinkage rate. From the above perspective, an upper limit of Tc/Ta is not more than 15.0, preferably not more than 10.0, and more preferably not more than 5.0. A lower limit of Tc/Ta is not particularly restricted and may, for example, be not less than 1.5, preferably not less than 2.0.

It is preferable that Ta of the present separator be not less than a predetermined value, from the perspective of controlling the values of Tb/Ta and Tc/Ta to suitably fall within the above-described upper limit ranges to enable further improvement of the heat resistance and also from the viewpoint of strength of the porous layer and the present separator itself. From this perspective, a lower limit of Ta is preferably not less than 0.10 N, more preferably not less than 0.15 N, and even more preferably not less than 0.20 N. An upper limit of Ta of the present separator is not particularly restricted and may, for example, be not more than 1.0 N, preferably not more than 0.80 N.

### <Porous Layer>

The porous layer included in the present separator ordinarily contains a resin. The resin is not limited. The resin may be, for example, at least one resin selected from the group consisting of: (meth)acrylate-based resins; fluorine-containing resins; polyester-based resins; rubbers; resins each having a melting point or a glass transition temperature of not lower than 180° C.; water-soluble polymers; and nitrogen-containing aromatic resins. The resin is preferably at least one resin selected from the group consisting of: (meth)acrylate-based resins; fluorine-containing resins; polyester-based resins; water-soluble polymers; and nitrogen-containing aromatic resins.

The (meth)acrylate-based resins are not particularly limited, and examples thereof include methyl acrylate, n-butyl acrylate, and 2-ethylhexyl acrylate.

The fluorine-containing resins are not particularly limited, and examples thereof include polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins include fluorine-containing rubber having a glass transition temperature of not higher than 23° C.

Examples of the polyester-based resins include aromatic polyesters such as a polyarylate and liquid crystal polyesters.

Examples of the rubbers include a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate.

Examples of the resins each having a melting point or a glass transition temperature of not lower than 180° C. include polyphenylene ether, polysulfone, polyether sulfone, polyphenylene sulfide, polyetherimide, polyamide imide, polyether amide, and polyether ether ketone.

Examples of the water-soluble polymers include polyvinyl alcohol, polyethylene glycol, cellulose ether, sodium alginate, polyacrylic acid, polyacrylamide, and polymethacrylic acid.

In the present specification, a nitrogen-containing resin means a resin containing a nitrogen atom. In the present specification, an aromatic resin means a resin containing a structural unit having at least an aromatic group. In the present specification, a nitrogen-containing aromatic resin means a resin that falls under both a nitrogen-containing resin and an aromatic resin. Examples of the nitrogen-containing aromatic resin include aromatic polyamides such as a wholly aromatic polyamide (aramid resin) and a semi-aromatic polyamide, aromatic polyimides, aromatic polyamide imides, polybenzimidazoles, aromatic polyurethanes, and melamine resins. From the perspective of heat resistance, the resin contained in the porous layer is preferably an aramid resin among the nitrogen-containing aromatic resins.

Examples of the aramid resin include para-aramids and meta-aramids. Among these, para-aramids are preferable. Examples of the para-aramids include para-aramids each having a para-oriented structure or a quasi-para-oriented structure, such as poly(para-phenylene terephthalamide), poly(para-benzamide), poly(4,4′-benzanilide terephthalamide), poly(para-phenylene-4,4′-biphenylenedicarboxamide), poly(para-phenylene-2,6-naphthylenedicarboxamide), poly(2-chloro-para-phenylene terephthalamide), a para-phenylene terephthalamide/2,6-dichloro-para-phenylene terephthalamide copolymer, poly(4,4′-diphenylsulfonyl terephthalamide), and a para-phenylene terephthalamide/4,4′-diphenylsulfonyl terephthalamide copolymer. Examples of the meta-aramids include poly(meta-phenylene terephthalamide), poly(meta-phenylene isophthalamide), poly(meta-benzamide), poly(meta-phenylene-4,4′-biphenylenedicarboxamide), and poly(meta-phenylene-2,6-naphthylenedicarboxamide). Poly(meta-phenylene isophthalamide) is also referred to as poly[N,N′-(1,3-phenylene) isophthalamide].

In an embodiment of the present invention, it is preferable to select a resin, as the aforementioned resin, that can suitably reduce the viscosity coefficient of the porous layer. Such resin is not particularly limited, and examples thereof may include a combination of a resin having a rigid structure and a resin having a flexible structure. Hereinafter, the “resin having a rigid structure” may also be referred to as a “rigid resin,” and the “resin having a flexible structure” may also be referred to as a “flexible resin”. Specifically, when the porous layer has a configuration in which the porous layer contains the aforementioned combination as the resin and the flexible resin is unevenly distributed, the viscosity coefficient can be suitably reduced. In this case, the rigid resin forms robust fibrils, and the fibrils form an internal structure of the porous layer except a surface layer part of the porous layer. The flexible resin is prevented from being incorporated into an internal structure of each of the fibrils and forming co-crystals with the rigid resin, and a surface layer part of the fibril is thus formed by the flexible resin. Accordingly, within the porous layer having the above configuration, the flexible resin is unevenly distributed, and the portions where the flexible resin is localized tend to move easily in response to external forces. As such, the porous layer having the above configuration exhibits a suitably reduced viscosity coefficient due to the ease of movement within the porous layer.

In the method for forming the porous layer described later, from the perspective of easily forming a porous layer that is included in the present separator and has a suitably reduced viscosity coefficient μ, it is preferable that the resin be a combination of a rigid resin and a flexible resin. It should be noted that, in the present specification, a lower limit of a ratio of a weight-average molecular weight of the rigid resin to a weight-average molecular weight of the flexible resin is preferably not less than 2.5, and more preferably not less than 4.5. An upper limit of this weight-average molecular weight ratio is preferably not more than 10, and more preferably not more than 8. The weight-average molecular weight ratio is calculated by dividing the larger weight-average molecular weight by the smaller weight-average molecular weight among the weight-average molecular weight of the rigid resin and the weight-average molecular weight of the flexible resin.

The rigid resin may be a resin that is publicly known as having a rigid structure. Examples of the rigid resin include poly(para-phenylene terephthalamide), poly(2-chloro-para-phenylene terephthalamide), poly(para-benzamide), and poly(4,4′-benzanilide terephthalamide). The flexible resin may be a resin that is publicly known as having a flexible structure. Examples of the flexible resin include poly(4,4′-diphenylsulfonyl terephthalamide), a para-phenylene terephthalamide/4,4′-diphenylsulfonyl terephthalamide copolymer, and a meta-aramid.

If the resin contains a nitrogen-containing aromatic resin, it is more preferable that the resin contain a first nitrogen-containing aromatic resin and a second nitrogen-containing aromatic resin. In this case, a weight ratio of the first nitrogen-containing aromatic resin to the second nitrogen-containing aromatic resin is preferably 20:80 to 80:20, more preferably 30:70 to 70:30, and even more preferably 40:60 to 60:40. Note here that the second nitrogen-containing aromatic resin may be a nitrogen-containing aromatic resin having a structure different from that of the first nitrogen-containing aromatic resin. Examples of a combination of the first nitrogen-containing aromatic resin and the second nitrogen-containing aromatic resin include a combination of a nitrogen-containing aromatic resin having a rigid structure and a nitrogen-containing aromatic resin having a flexible structure.

While the combination of a rigid resin and a flexible resin between which the above-described weight-average molecular weight ratio falls within a predetermined range is as described above, the configuration of the porous layer is not limited thereto. The porous layer may have any configuration that suitably reduces the viscosity coefficient and suitably reduces Tb/Ta and Tc/Ta. Examples of the configuration include a polymer having a relatively rigid substructure and a flexible substructure, and typically, a polymer having, as part of a main chain structure thereof, an aromatic polyamide and a substructure of an aliphatic polyamide.

Furthermore, the porous layer may be configured such that the porous layer contains a controlled amount of filler with controlled average particle diameter, particle diameter distribution, and/or shape, whereby Tb/Ta and Tc/Ta are suitably reduced. Typically, the porous layer may be configured such that the porous layer contains a filler with an adjusted particle diameter distribution and a content of the filler is adjusted, whereby Tb/Ta and Tc/Ta are suitably reduced.

The porous layer can be a heat-resistant layer. The heat-resistant layer means a layer having a higher melting temperature than a substrate. The resin contained in the porous layer can be a resin having heat resistance. The resin having heat resistance can be a resin having a higher melting point or glass transition temperature than a resin constituting the substrate. The resin contained in the porous layer is preferably a resin that is insoluble in an electrolyte of the electrochemical device and that is electrochemically stable when the electrochemical device is in normal use.

The filler can be an inorganic filler or an organic filler. The filler is preferably a filler made of an inorganic oxide such as silica, calcium oxide, magnesium oxide, magnesium hydroxide, barium sulfate, titanium oxide, alumina, mica, zeolite, aluminum hydroxide, or boehmite, more preferably a filler made of calcium oxide, magnesium oxide, magnesium hydroxide, barium sulfate, alumina, or boehmite, and still more preferably a filler made of alumina.

Examples of the organic filler include: homopolymers of monomers such as styrene, vinyl ketone, acrylonitrile, methyl methacrylate, ethyl methacrylate, glycidyl methacrylate, glycidyl acrylate, and methyl acrylate, or copolymers of two or more of these monomers; fluorine-based resins such as polytetrafluoroethylene, tetrafluoroethylene-hexafluoropropylene copolymers, tetrafluoroethylene-ethylene copolymers, and polyvinylidene fluoride; melamine resins; urea resins; polyolefins; and polymethacrylates. Each of these organic fillers may be used alone or two or more of these organic fillers may be alternatively used in combination. Among these organic fillers, a polytetrafluoroethylene powder is preferable in terms of chemical stability. Alternatively, the organic filler may be polyolefin in order to improve a shutdown property of the separator. Use of polyolefin as the organic filler makes it possible to impart a shutdown property to the porous layer.

A filler content in 100% by weight of the porous layer may be 0% by weight to 95% by weight, may be 0% by weight to 90% by weight, may be 0% by weight to 80% by weight, may be 0% by weight to 60% by weight, may be 0% by weight to 20% by weight, may be 0% by weight to 15% by weight, may be 0% by weight to 10% by weight, or may be 0% by weight to 5% by weight. A filler content of 0% by weight means that the porous layer does not contain the filler. In order to ensure ion permeability, the filler content in 100% by weight of the porous layer may be more than 0% by weight, or may be not less than 1% by weight.

The filler has an average particle diameter of preferably 0.01 μm to 1 μm, more preferably 0.01 μm to 0.8 μm, still more preferably 0.01 μm to 0.5 μm, even more preferably 0.01 μm to 0.1 μm, and particularly preferably 0.01 μm to 0.05 μm. The filler having an average particle diameter of not less than 0.01 μm easily causes pores in the porous layer to have a larger pore diameter. This makes it difficult for ion permeability of a separator to decrease even if the separator is compressed in a battery. Further, since the filler having an average particle size of not less than 0.01 μm easily causes unevenness to be formed on the surface of the porous layer, the separator can have an improved antistatic property and improved slidability. Meanwhile, the filler having an average particle diameter of not more than 1 μm allows the separator to have improved heat resistance and to be thinner. In order to achieve both these properties, it is possible to use, in combination, fillers having different average particle diameters, or to use a filler having a wide particle size distribution. The average particle diameter of the filler has a lower limit that is not particularly limited and may be, for example, 0.005 μm.

Note here that the average particle diameter of the filler is an average value of sphere equivalent particle diameters of 50 particles of the filler. Further, the sphere equivalent particle diameters of the filler are values obtained by actual measurement with use of a transmission electron microscope. The following is a specific example of a method for measuring the average particle size of the filler.
1. An image of the filler is captured by using a transmission electron microscope (TEM; JEOL Ltd., transmission electron microscope JEM-2100F) at an acceleration voltage of 200 kV and at a magnification ratio of 10,000 times with use of a Gatan Imaging Filter.
2. In the image thus obtained, an outline of a particle is traced by using image analysis software (ImageJ) and a sphere equivalent particle diameter of a filler particle (primary particle) is measured.
3. The above measurement is carried out for 50 filler particles that have been randomly extracted. An arithmetic average of sphere equivalent particle diameters of the 50 filler particles is regarded as the average particle diameter of the filler.

The porous layer may contain another component different from the resin and the filler, provided that the object of the present invention is not prevented from being attained. For example, the porous layer may contain, as the another component, an additive that is generally used in a separator. The another component may be one type of component, or may be a mixture of two or more types of components.

Examples of the additive include a flame retardant, an antioxidant, a surfactant, a lithium imide salt, and wax. If the porous layer is prone to charging, the charging of the porous layer can be suppressed by adding a surfactant or lithium imide salt. Examples of the surfactant include nonionic surfactants such as a glycerin fatty acid ester, a polyoxyethylene alkyl ether, and a polyoxyethylene alkylamine, anionic surfactants such as an alkyl sulfonic acid, cationic surfactants such as a tetraalkylammonium salt, and amphoteric surfactants such as an alkylbetaine. Examples of the lithium imide salt include bis(trifluoromethanesulfonyl)imide lithium and bis(pentafluoroethanesulfonyl)imide lithium. Further, addition of the flame retardant and/or a crosslinking agent allows a separator to have higher safety and higher heat resistance.

In order to ensure adhesion between the separator and an electrode and a high energy density of the electrochemical device, the porous layer has a thickness per layer of preferably 0.15 μm to 5 μm, more preferably 0.25 μm to 5 μm, and still more preferably 0.35 μm to 3 μm. The porous layer having a thickness per layer of not less than 0.15 μm (i) makes it possible to sufficiently prevent or reduce an internal short circuit which might occur due to, for example, breakage of the electrochemical device and (ii) allows the porous layer to retain an electrolyte in an adequate amount. If the thickness of the porous layer is not more than 5 μm per layer, it is possible in the electrochemical device to minimize resistance to metal ion permeation and thus to minimize a decrease in rate characteristic and in cycle characteristic. Further, if the porous layer has a thickness per layer of not more than 5 μm, it is also possible to minimize an increase in distance between the positive electrode and the negative electrode. This makes it possible to minimize a reduction in internal volume efficiency of the electrochemical device.

A weight per unit area of the porous layer can be determined as appropriate in view of the strength, thickness, weight, and handleability of the porous layer. The porous layer has a weight per unit area per layer of preferably 0.15 g/m² to 10 g/m², and more preferably 0.25 g/m² to 5 g/m². The porous layer having a weight per unit area in the above numerical range allows the electrochemical device to have a higher weight energy density and a higher volume energy density.

The porous layer has a porosity of preferably 20% by volume to 90% by volume, and more preferably 30% by volume to 80% by volume, in order to achieve sufficient ion permeability. Pores of the porous layer have a diameter of preferably not more than 1.0 μm, more preferably not more than 0.5 μm, and even more preferably not more than 0.05 μm. A lower limit of the diameter of the pores is not particularly restricted and, for example, may be not less than 0.01 μm or may be not less than 0.02 μm. If the pores have such a diameter, the electrochemical device can achieve sufficient ion permeability.

### <Porous Substrate>

The present separator has a configuration in which the porous layer is formed on at least one surface of the porous substrate. That is, the present separator includes the porous substrate. The porous substrate of the present separator is not particularly limited, and can be, for example, a polyolefin porous substrate.

In the present specification, the polyolefin porous substrate means a porous substrate that contains a polyolefin-based resin as a main component. The phrase “contain a polyolefin-based resin as a main component” means that the polyolefin-based resin is contained, in the porous substrate, at a proportion of not less than 50% by weight, preferably not less than 90% by weight, and more preferably not less than 95% by weight with respect to all materials that constitute the porous substrate. The porous substrate can be a polyolefin porous film.

The polyolefin-based resin more preferably contains a high molecular weight component having a weight-average molecular weight of 5×10⁵ to 15×10⁶. In particular, the polyolefin-based resin that contains a high molecular weight component having a weight-average molecular weight of not less than 1,000,000 is more preferable because such a polyolefin-based resin allows the resulting present separator to have increased strength.

The polyolefin-based resin is exemplified by, but not particularly limited to, thermoplastic resins each obtained by polymerizing a monomer(s) such as ethylene, propylene, 1-butene, 4-methyl-1-pentene, 1-hexene, and/or the like, such as homopolymers and copolymers. Examples of the homopolymers include polyethylene, polypropylene, and polybutene. Examples of the copolymers include an ethylene-propylene copolymer.

Among the above examples of polyolefin-based resins, polyethylene is more preferable because polyethylene makes it possible to prevent a flow of an excessively large electric current to the present separator at a lower temperature. Note that preventing the flow of an excessively large electric current is also referred to as “shutdown”. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is still more preferable.

The polyolefin porous substrate may have a multilayer structure including two or more layers. Examples of the polyolefin porous substrate having the multilayer structure include a polyolefin porous substrate in which a layer containing polyethylene as a main component and a layer containing polypropylene as a main component are formed on top of each other. The number of layers formed on top of each other in the polyolefin porous substrate is not particularly limited. The polyolefin porous substrate may include two layers consisting of a layer containing polyethylene as a main component and a layer containing polypropylene as a main component, or may include three layers consisting of a combination of a layer containing polyethylene as a main component and a layer containing polypropylene as a main component. The polyolefin porous substrate having the multilayer structure including a layer containing polyethylene as a main component and a layer containing polypropylene as a main component makes it possible to achieve both a shutdown property and heat resistance.

The polyolefin porous substrate may have a crosslinked structure. The crosslinked structure can be introduced by, for example, using silane-modified polyolefin. The polyolefin porous substrate having the crosslinked structure has excellent heat resistance. Thus, a combination of such a polyolefin porous substrate with a porous layer having heat resistance allows the present separator to have higher heat resistance. Note that the crosslinked structure may be provided between the polyolefin porous substrate and the porous layer.

The porous substrate has a thickness of preferably 4 μm to 40 μm, and more preferably 5 μm to 20 μm. The porous substrate having a thickness of not less than 4 μm makes it possible to sufficiently prevent an internal short circuit in the electrochemical device. Meanwhile, the porous substrate having a thickness of not more than 40 μm makes it possible to prevent an increase in size of the electrochemical device.

A weight per unit area of the porous substrate can be determined as appropriate in view of the strength, thickness, weight, and handleability of the porous substrate. Note, however, that the weight per unit area is preferably 4 g/m² to 20 g/m², more preferably 4 g/m² to 12 g/m², and still more preferably 5 g/m² to 10 g/m², so as to allow the electrochemical device to have a higher weight energy density and a higher volume energy density.

The porous substrate has therein many pores connected to one another. This allows a gas and a liquid to pass through the porous substrate from one side to the other side. The porous substrate has an air permeability of preferably 30 s/100 mL to 500 s/100 mL, and more preferably 50 s/100 mL to 300 s/100 mL. The porous substrate having the above air permeability can have sufficient ion permeability. The air permeability is measured in conformity with JIS P 8117 and is expressed in Gurley values.

The porous substrate has a porosity of preferably 20% by volume to 80% by volume, and more preferably 30% by volume to 75% by volume, so as to (i) retain a larger amount of an electrolyte and (ii) obtain the function of reliably preventing a flow of an excessively large electric current at a lower temperature. In order to achieve sufficient ion permeability and prevent particles from entering the positive electrode and/or the negative electrode, the porous substrate has pores each having a pore diameter of preferably not more than 0.3 μm, and more preferably not more than 0.14 μm.

### <Physical Properties of the Present Separator>

The present separator has a thickness of preferably 3.5 μm to 45 μm, more preferably 3.5 μm to 25 μm, still more preferably 3.5 μm to 20 μm, and particularly preferably 3.5 μm to 18 μm. The separator having a thickness of not less than 3.5 μm makes it possible to sufficiently prevent an internal short circuit in the electrochemical device. Meanwhile, the present separator having a thickness of not more than 45 μm makes it possible to prevent an increase in size of the electrochemical device. The thickness of the present separator may be 5.5 μm to 45 μm, or may be 6 μm to 25 μm.

The present separator has an air permeability of preferably 30 s/100 mL to 1,000 s/100 mL, more preferably 50 s/100 mL to 800 s/100 mL, and still more preferably 70 s/100 mL to 500 s/100 mL. The present separator having the above air permeability can achieve sufficient ion permeability in the electrochemical device. The air permeability is measured in conformity with JIS P 8117 and is expressed in Gurley values.

### <Configuration of the Present Separator>

The present separator has a configuration in which the porous layer is formed on at least one surface of the porous substrate. That is, the present separator may be configured to include a porous layer provided on one surface of the above-described porous substrate, or may be configured to include porous layers provided on both surfaces of the porous substrate. Further, a first porous layer and a second porous layer that are provided on both surfaces of the porous substrate may be identical to or different from each other in thickness, weight per unit area, and porosity. Furthermore, the porous layers provided on both surfaces of the porous substrate may have makeups different from each other. The makeups different from each other indicate that front and back porous layers differ in, for example, (i) types of resin and filler which are contained in a porous layer and (ii) filler filling amount. Note that the examples shown in the foregoing description of the porous layer are applicable to the resin and the filler, and the filler filling amount.

The present separator may include, as necessary, another functional layer different from the above-described porous substrate and the above-described porous layer (e.g., heat-resistant layer), provided that the object of the present invention is not prevented from being attained. Examples of the another functional layer include publicly-known porous layers such as an adhesive layer, a protective layer, a shutdown layer, an antistatic layer, and an easy sliding layer.

The another functional layer can be provided on one surface of the present separator or on both surfaces of the present separator. If the present separator includes the above-described porous layer on both surfaces of the porous substrate, the another functional layer may be provided on the porous layer on both surfaces of the present separator, or may be provided on the porous layer on one surface of the present separator. If the present separator includes the above-described porous layer only on one surface of the porous substrate, the another functional layer may be provided on the porous layer, or may be provided on a surface of the porous substrate on which surface the porous layer is not provided. The another functional layer can be provided on an outermost layer of the present separator.

For example, the present separator further includes an adhesive layer separately from the above-described porous substrate and the above-described porous layer. In the present specification, the adhesive layer means a porous layer having adhesiveness. The adhesive layer can be provided on a surface of the present separator which surface is in contact with the electrode. Examples of a component that is contained in the adhesive layer and that contributes to adhesiveness include an acrylic resin and a PVdF-based resin. Examples of the acrylic resin include acrylic resins listed in paragraphs [0072] to [0088] of Japanese Patent Application Publication Tokukai No. 2024-006988. Examples of the PVdF-based resin include PVdF-based resins listed in paragraphs [0017] to [0022] of Japanese Patent Application Publication Tokukai No. 2017-168419. The acrylic resin and the PVdF-based resin may be used alone or in combination. The adhesive layer may further contain a filler in addition to the component that contributes to adhesiveness. The filler can be a filler similar to that added to the porous layer.

A state in which the adhesive layer is present is not particularly limited. The component that contributes to adhesiveness may be present in particulate form, or may be present as a homogeneous coating layer. Alternatively, pattern coating may be used to cause the adhesive layer to be present in dot form or in stripe form. Providing the adhesive layer fixes the present separator to an electrode via the adhesive layer, so that an electrode laminated body can be obtained. This makes it possible to improve handleability and heat resistance of the electrode laminated body. Further, causing the adhesive layer to be present in particulate form, in dot form, or in stripe form makes it possible to prevent or reduce a decrease in ion permeability of a laminated separator.

### <Method for Producing the Present Separator>

A method for producing the present separator is not particularly limited. Examples of the method include a method of producing the present separator by forming a porous layer on at least one surface of the porous substrate with use of a coating solution obtained by dissolving or dispersing the resin in a solvent. Note that the solvent can be described as being a dispersion medium in which a resin is dispersed. Examples of a method for preparing the coating solution include a mechanical stirring method, an ultrasonic dispersion method, a high-pressure dispersion method, and a media dispersion method.

Examples of a method for forming the porous layer on at least one surface of the porous substrate include (i) a method of applying the coating solution directly to a surface of the porous substrate and then removing the solvent, (ii) a method of applying the coating solution to an appropriate support, subsequently removing the solvent so as to form a porous layer, pressure-bonding the porous layer to the porous substrate, and peeling the support off, (iii) a method of applying the coating solution to a surface of an appropriate support, pressure-bonding the porous substrate to that surface, peeling the support off, and then removing the solvent, or (iv) a method of carrying out dip coating by immersing the porous substrate into the coating solution, and then removing the solvent.

The solvent preferably (i) does not have an adverse effect on the substrate, (ii) allows the resin to be uniformly and stably dissolved in the solvent, and (iii) allows the filler to be uniformly and stably dispersed in the solvent. Examples of the solvent include N-methyl-2-pyrrolidone (NMP), N,N-dimethylacetamide, N,N-dimethylformamide, acetone, and water.

The coating solution may contain a filler. As necessary, the coating solution may contain, as a component(s) other than the resin and the filler, for example, a disperser, a plasticizer, a surfactant, and/or a pH adjuster.

The coating solution can be applied to the substrate by a conventionally known method. Specific examples of such a method include a gravure coater method, a dip coater method, a bar coater method, and a die coater method.

Before applying the coating solution to the substrate, the substrate may be impregnated with a solvent. The solvent with which the substrate is impregnated is preferably the same solvent as the solvent contained in the coating liquid, or an aqueous solution containing the same solvent as the solvent in the coating solution at a high concentration (not less than 70% by weight and less than 100 wt %). For example, when the solvent in the coating liquid is NMP, it is preferable to impregnate the substrate with NMP or an aqueous solution containing NMP at a high concentration before applying the coating solution. The surface of the substrate to which the coating solution is applied and the surface of the substrate to which the solvent is applied are different surfaces. In the present specification, this method of impregnating the substrate with the solvent is also referred to as opposite surface impregnation. The solvent used for the opposite surface impregnation is particularly preferably NMP or an aqueous solution containing 70% by weight to 99% by weight of NMP.

If the coating solution contains an aramid resin, the aramid resin can be deposited by applying moisture to a surface to which the coating solution is applied. The porous layer may be formed in this way. A specific method of applying moisture to the surface to which the coating solution is applied is exemplified by, but not particularly limited to, a method of exposing the surface to a high-humidity atmosphere, a method of spraying water with use of a spray or the like, and a method of blowing water vapor via a nozzle or the like.

The present separator is, as described above, a separator provided with a porous layer in which the viscosity coefficient μ is suitably reduced. A method for forming the porous layer in which the viscosity coefficient is suitably reduced is not particularly limited, and examples thereof include a method in which a combination of a rigid resin and a flexible resin is used as the resin. According to this method, the flexible resin is deposited more slowly than the rigid resin due to having high solubility in the solvent. Thus, by using the method, for example, without requiring complex operations such as changing deposition conditions (described later) overtime, a porous layer having a suitably reduced viscosity coefficient can be easily formed, since the flexible resin is unevenly distributed on the surface.

The flexible resin can be prepared with use of a publicly-known method. For example, as a method for preparing an aramid resin with a flexible structure as the flexible resin, the following method can be mentioned. Hereinafter, an aramid resin having a flexible structure will be referred to as a “flexible aramid resin”.

A method in which an aromatic diamine component and an aromatic dicarboxylate component, which are to be included in the flexible aramid resin, are selected as monomers, and a molar ratio of the aromatic diamine component and the aromatic dicarboxylate component is adjusted to a ratio different from 1:1.

As another method, for example, a method can be mentioned in which a combination of a rigid resin and a flexible resin is used, and the deposition conditions are changed over time so that the flexible resin is deposited after the rigid resin has been deposited. Examples of the deposition conditions may include temperature and humidity. Also with use of the another method, a porous layer having a suitably reduced viscosity coefficient can be easily formed as with the above-described method, since the flexible resin is unevenly distributed on the surface.

A method for producing the porous substrate is not particularly limited. Examples of the production method include the following method.

A polyolefin resin composition in sheet form is produced by kneading a polyolefin-based resin together with a pore forming agent such as an inorganic bulking agent or a plasticizer, and optionally with another agent(s) such as an antioxidant, and then extruding the kneaded substances. The pore forming agent is then removed from the polyolefin resin composition in sheet form with use of a suitable solvent. Thereafter, the porous substrate can be produced by stretching the polyolefin-based resin composition from which the pore forming agent has been removed.

The inorganic bulking agent is exemplified by, but not particularly limited to, an inorganic filler, specific examples of which include calcium carbonate. The plasticizer is exemplified by, but not particularly limited to, a low molecular weight hydrocarbon such as liquid paraffin.

### [2. Material, Electrochemical Device]

A material in accordance with an embodiment of the present invention includes a positive electrode, a separator described above, and a negative electrode, the positive electrode, the separator, and the negative electrode being arranged in this order. An electrochemical device in accordance with an embodiment of the present invention includes a separator described above.

Examples of the electrochemical device include a secondary battery and a capacitor. Examples of the secondary battery include a nonaqueous electrolyte secondary battery such as a lithium ion secondary battery. Examples of the capacitor include an electric double layer capacitor. A nonaqueous electrolyte secondary battery is not particularly limited in shape and can have any shape such as the shape of a thin plate (sheet), a disk, a cylinder, or a prism such as a cuboid.

For example, the material can be formed by arranging the positive electrode, the above-described separator, and the negative electrode in this order. The porous layer can be provided between the porous substrate and at least one of the positive electrode and the negative electrode. The material is then placed in a container that serves as a housing for the electrochemical device. In this manner, it is possible to produce the electrochemical device. In the case of a nonaqueous electrolyte secondary battery, the container is filled with a nonaqueous electrolyte (described later) and then hermetically sealed while pressure is reduced in the container.

### <Positive Electrode>

The positive electrode is not limited to any particular one, provided that the positive electrode is one that is generally used as a positive electrode of an electrochemical device. Examples of the positive electrode include a positive electrode sheet having a structure in which an active material layer containing a positive electrode active material and a binding agent is formed on a positive electrode current collector. The active material layer may further contain an electrically conductive agent.

Examples of the positive electrode active material include materials each capable of being doped with and dedoped of metal ions such as lithium ions or sodium ions. Specific examples of the materials include a lithium-containing complex metal oxide containing lithium (Li) and at least one transition metal selected from the group consisting of V, Cr, Mn, Fe, Co, Ni, Cu, and Al. Examples of such a lithium-containing complex metal oxide include LiCoO₂, LiNiO₂, LiMn₂O₄, Li₂MnO₃, LiNiₓMn_{y}Co_{1-x-y}O₂ [0<x+y<1], LiNiₓCo_{y}Al_{1-x-y}O₂ [0<x+y<1], LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄.

Examples of the electrically conductive agent include carbonaceous materials such as natural graphite, artificial graphite, cokes, carbon black (e.g., acetylene black), pyrolytic carbons, fibrous carbon materials, and fired products of organic polymer compounds. Each of the above electrically conductive agents may be used alone. Alternatively, two or more of the above electrically conductive agents may be used in combination. A proportion of the electrically conductive agent in a positive electrode mix is preferably not less than 5 parts by mass and not more than 20 parts by mass with respect to 100 parts by mass of the positive electrode active material. The proportion may be reduced if a fibrous carbon material such as graphitized carbon fiber or a carbon nanotube is used as the electrically conductive agent.

The binding agent can be a thermoplastic resin. Examples of the thermoplastic resin include fluorine-based resins such as PVdF, polytetrafluoroethylene (PTFE), a tetrafluoroethylene-hexafluoropropylene-vinylidene fluoride-based copolymer, a hexafluoropropylene-vinylidene fluoride-based copolymer, and a tetrafluoroethylene-perfluorovinyl ether-based copolymer, acrylic resins, styrene butadiene rubber, polyimide resins, and polyolefin resins. Note that the binding agent serves also as a thickener. It is possible to use a mixture of two or more of these thermoplastic resins. A positive electrode mix that has both great adhesion to the positive electrode current collector and a high bonding strength inside the positive electrode mix can be obtained by using a fluorine-based resin and a polyolefin resin as a binder to adjust a ratio of the fluorine-based resin to all the positive electrode mix to not less than 1% by mass and not more than 10% by mass, and adjust a ratio of the polyolefin resin to all the positive electrode mix to not less than 0.1% by mass and not more than 2% by mass.

Examples of the positive electrode current collector include electric conductors such as Al, Ni, and stainless steel. Among these electric conductors, Al is more preferable because Al is easily processed into a thin film and is inexpensive.

Examples of a method for producing the positive electrode sheet include: a method in which the positive electrode active material, the electrically conductive agent, and the binding agent (positive electrode mix) are pressure-molded on the positive electrode current collector; and a method in which (i) the positive electrode mix is formed into a paste with use of an appropriate organic solvent, (ii) the positive electrode current collector is coated with the paste, and (iii) the paste is dried and then pressure is applied so that the paste is firmly fixed to the positive electrode current collector.

Examples of an organic solvent that can be used in the above method include: amine-based solvents such as N,N-dimethylaminopropylamine and diethylenetriamine; ether-based solvents such as tetrahydrofuran; ketone-based solvents such as methyl ethyl ketone; ester-based solvents such as methyl acetate; and amide-based solvents such as dimethylacetamide and NMP.

Examples of a method of applying a paste of the positive electrode mix to the positive electrode current collector include a slit-die coating method, a screen coating method, a curtain coating method, a knife coating method, a gravure coating method, and an electrostatic spray method.

### <Negative Electrode>

The negative electrode is not limited to any particular one, provided that the negative electrode is one that is generally used as a negative electrode of an electrochemical device. Examples of the negative electrode include a negative electrode sheet having a structure in which an active material layer containing a negative electrode active material and a binding agent is formed on a negative electrode current collector. The active material layer may further contain an electrically conductive agent.

Examples of the negative electrode active material include materials each capable of being doped with and dedoped of metal ions such as lithium ions or sodium ions. Examples of the materials include materials which are carbonaceous materials, chalcogen compounds (such as oxides and sulfides), nitrides, metals, and alloys and each of which is capable of being doped with and dedoped of lithium ions at electric potentials lower than that of the positive electrode. Examples of the carbonaceous materials include natural graphite, artificial graphite, cokes, carbon black, and pyrolytic carbons.

Examples of the oxides that can be used as the negative electrode active material include: oxides of silicon which are represented by a formula SiOₓ (where x is a positive real number), such as SiO₂ and SiO; oxides of titanium which are represented by a formula TiOₓ (where x is a positive real number), such as TiO₂ and TiO; oxides of vanadium which are represented by a formula VOₓ (where x is a positive real number), such as V₂O₅ and VO₂; oxides of iron which are represented by a formula FeOₓ (where x is a positive real number), such as Fe₃O₄, Fe₂O₃, and FeO; oxides of tin which are represented by a formula SnOₓ (where x is a positive real number), such as SnO₂ and SnO; oxides of tungsten which are represented by a general formula WOₓ (where x is a positive real number), such as WO₃ and WO₂; and complex metal oxides each of which contains lithium and titanium or vanadium, such as Li₄Ti₅O₁₂ and LiVO₂.

Examples of the sulfides that can be used as the negative electrode active material include: sulfides of titanium which are represented by a formula TiSₓ (where x is a positive real number), such as Ti₂S₃, TiS₂, and TiS; sulfides of vanadium which are represented by a formula VSₓ (where x is a positive real number), such as V₃S₄, VS₂, and VS; sulfides of iron which are represented by a formula FeSₓ (where x is a positive real number), such as Fe₃S₄, FeS₂, and FeS; sulfides of molybdenum which are represented by a formula MoSₓ (where x is a positive real number), such as Mo₂S₃ and MoS₂; sulfides of tin which are represented by a formula SnSₓ (where x is a positive real number), such as SnS₂ and SnS; sulfides of tungsten which are represented by a formula WSₓ (where x is a positive real number), such as WS₂; sulfides of antimony which are represented by a formula SbSₓ (where x is a positive real number), such as Sb₂S₃; and sulfides of selenium which are represented by a formula SeSx (where x is a positive real number), such as Se₅S₃, SeS₂, and SeS.

Examples of the nitrides that can be used as the negative electrode active material include lithium-containing nitrides such as Li₃N and Li₃₋ₓAₓN (where A is one or both of Ni and Co, and 0<x<3 is satisfied).

Each of these carbonaceous materials, oxides, sulfides, and nitrides may be used alone or two or more of these carbonaceous materials, oxides, sulfides, and nitrides may be used in combination. These carbonaceous materials, oxides, sulfides, and nitrides may be each crystalline or amorphous.

Examples of the metals that can be used as the negative electrode active material include lithium metals, silicon metals, and tin metals.

Examples of the alloys that can be used as the negative electrode active material include lithium alloys such as Li—Al, Li—Ni, Li—Si, Li—Sn, and Li—Sn—Ni; silicon alloys such as Si—Zn; tin alloys such as Sn—Mn, Sn—Co, Sn—Ni, Sn—Cu, and Sn—La; and alloys such as Cu₂Sb and La₃Ni₂Sn₇.

These metals and alloys are each mainly solely used as an electrode after being processed into, for example, foil form. Among the above-listed negative electrode active materials, a carbonaceous material that contains, as a main component, graphite such as natural graphite or artificial graphite is preferably used. This is because such a carbonaceous material hardly changes in electric potential of a negative electrode (has good potential evenness) from an uncharged state to a fully charged state during charging, has a low average discharge potential, and has a high capacity maintenance rate (has a good cycle characteristic) when charging and discharging are repeatedly carried out. The shape of the carbonaceous material may be, for example, any of the following: a flake shape like natural graphite; a spherical shape like mesocarbon microbeads; a fibrous shape like graphitized carbon fiber; an aggregate of fine powders; and the like.

Examples of the negative electrode current collector include Cu, Ni, and stainless steel. Among these materials, Cu is more preferable because Cu is not easily alloyed with lithium and is easily processed into a thin film.

Examples of a method for producing the negative electrode sheet include: a method in which the negative electrode active material is pressure-molded on the negative electrode current collector; and a method in which (i) the negative electrode active material is formed into a paste with use of an appropriate organic solvent, (ii) the negative electrode current collector is coated with the paste, and (iii) the paste is dried and then pressure is applied so that the paste is firmly fixed to the negative electrode current collector. The paste preferably contains any of the above-listed electrically conductive agents and any of the above-listed binding agents.

The negative electrode sheet may contain a binder, as necessary. The binder can be, for example, a thermoplastic resin, specific examples of which include PVdF, thermoplastic polyimides, carboxymethyl cellulose, and polyolefin resins.

### <Nonaqueous Electrolyte>

A nonaqueous electrolyte is not limited to any particular one, provided that the nonaqueous electrolyte is one that is generally used for an electrochemical device, e.g., a nonaqueous electrolyte secondary battery. The nonaqueous electrolyte can be, for example, a nonaqueous electrolyte containing an organic solvent and a lithium salt dissolved in the organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, LiN(SO₂C₂F₅)₂, LiN(SO₂CF₃)(COCF₃), Li(C₄F₉SO₃), Li₂B₁₀Cl₁₀, LiBOB (where BOB refers to bis(oxalato)borate), LiFSI (where FSI refers to bis(fluorosulfonyl)imide), lower aliphatic carboxylic acid lithium salt, and LiAlCl₄. Each of the above lithium salts may be used alone. Alternatively, two or more of the above lithium salts may be used in combination. Among these electrolytes, it is preferable to use at least one fluorine-containing lithium salt selected from the group consisting of LiPF₆, LiAsF₆, LiSbF₆, LiBF₄, LiCF₃SO₃, LiN(SO₂CF₃)₂, and LiC(SO₂CF₃)₃.

Examples of the organic solvent include: carbonates such as propylene carbonate, ethylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoromethylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and solvents each prepared by further introducing a fluoro group into any of these organic solvents (i.e., solvents each prepared by substituting one or more hydrogen atoms of any of these organic solvents with one or more respective fluorine atoms). Each of the above organic solvents may be used alone. Alternatively, two or more of the above organic solvents may be used in combination. In particular, a mixed solvent containing a carbonate is preferable, and a mixed solvent containing a cyclic carbonate and an acyclic carbonate, and a mixed solvent containing a cyclic carbonate and an ether are more preferable. The mixed solvent containing a cyclic carbonate and an acyclic carbonate is preferably a mixed solvent containing ethylene carbonate, dimethyl carbonate, and ethyl methyl carbonate. The electrolyte that contains such a mixed solvent has many advantages of having a wide operating temperature range, being less prone to deterioration even when subjected to charging and discharging at a high current rate, being less prone to deterioration even when used for a long period of time, and being less prone to decomposition even when the negative electrode active material is a graphite material such as natural graphite or artificial graphite.

The present invention is not limited to the embodiments, but can be altered by a skilled person in the art within the scope of the claims. The present invention also encompasses, in its technical scope, any embodiment derived by combining technical means disclosed in differing embodiments.

An embodiment of the present invention may include the following features.
<1> A separator for an electrochemical device, the separator including: a porous substrate; and a porous layer formed on at least one surface of the porous substrate,
   the separator satisfying at least one of Expression (1) and Expression (2) below:

$$Tb / Ta \leq 5. \qquad ( 1 )$$

$$Tc / Ta \leq 15. \qquad ( 2 )$$

where Ta, Tb, and Tc represent respective peel strengths obtained as a result of performing peel tests on the separator under conditions of peel speeds of 1 mm/min, 100 mm/min, and 1000 mm/min, each of the peel tests being performed under a condition of a measurement temperature of 120° C. by a method in conformity with JIS K 6854-3.
<2> The separator described in <1>, wherein Ta is not less than 0.10 N.
<3> The separator described in <1> or <2>, wherein the porous layer contains one or more resins selected from the group consisting of a (meth)acrylate-based resin, a fluorine-containing resin, a polyester-based resin, a water-soluble polymer, and a nitrogen-containing aromatic resin.
<4> The separator described in <3>, wherein the nitrogen-containing aromatic resin is an aramid resin.
<5> The separator described in any one of <1> to <4>, further including an adhesive layer separately from the porous substrate and the porous layer.
<6> A material for an electrochemical device, the material including a positive electrode, a separator described in any one of <1> to <5>, and a negative electrode, the positive electrode, the separator, and the negative electrode being arranged in this order.
<7> An electrochemical device, including a separator described in any one of <1> to <5>.
<8> The electrochemical device described in <7>, wherein the electrochemical device is a secondary battery or a capacitor.

### EXAMPLES

The following description will discuss an example of the present invention. In the present specification, a direction in which the separator is transferred during production may also be referred to as a “machine direction” (MD), and a direction which is (i) parallel to the surface of the separator and (ii) perpendicular to the MD may also be referred to as a “transverse direction” (TD).

### [Measurement and Evaluation of Physical Properties]

### <Measurement of Molecular Weight of Resin>

With use of respective portions of a solution containing a resin A synthesized in Synthesis Example 1, a solution containing a resin B synthesized in Synthesis Example 2, and a solution containing a resin C synthesized in Comparative Synthesis Example 1, weight average molecular weights of the resin A, the resin B, and the resin C were measured by the method of size exclusion chromatography.

### <Measurement of Peel Strength Under Heating>

The separator was cut into a size of 27 mm×100 mm and bonded to a glass epoxy resin adherend with use of a double-sided tape. The cutting of the separator was carried out such that a longitudinal direction of the separator after cutting was aligned with the MD of the separator. Subsequently, Kapton tape (25 mm width) manufactured by Nitto Denko Corporation was attached to the separator as a peeling tape to prepare a test piece. The obtained test piece was placed inside a thermostatic chamber set to 120° C., and a peel test was conducted in conformity with JIS K 6854-3 to measure a peel strength [unit: N]. In so doing, the peeling speed was set to 1 mm/min. The peel test was conducted twice for each piece of separator, and an average value of the two peel strength measurements obtained from the respective peel tests was calculated. The calculated average value was defined as a peel strength Ta [unit: N] of the separator at a peeling speed of 1 mm/min.

Similar measurements and calculations of an average value were conducted at a peeling speed of 100 mm/min, and the calculated average value was defined as a peel strength Tb [unit: N] of the separator at a peeling speed of 100 mm/min. Further, similar measurements and calculations of an average value were conducted at a peeling speed of 1000 mm/min, and the calculated average value was defined as a peel strength Tc [unit: N] of the separator at a peeling speed of 1000 mm/min.

### <Average Pore Diameter of Porous Layer>

An average pore diameter of the porous layer included in the separator was measured with use of Perm Porometer (model: CFP-1500A) manufactured by Porous Materials Inc. Note here that for measurement, GalWick (product name) manufactured by Porous Materials Inc. was used as a test liquid to obtain the following curves (i) and (ii):
(i) a pressure-flow rate curve for the porous layer as immersed in the test liquid; and
(ii) a pressure-flow rate curve for the porous layer as measured in a dried state and with the flow rate halved.

The average pore diameter [unit: nm] of the porous layer was calculated with use of Expression (4) below on the basis of the value of a pressure corresponding to a point of intersection of the curves (i) and (ii).

Average pore diameter[unit:nm]=4 cos θ×rP×1000 (4):

where r represents surface tension [unit: mN/m] of the test liquid, P represents the above-mentioned pressure [unit: Pa] corresponding to the point of intersection, and θ represents a contact angle [unit: ° ] between the porous layer and the test liquid.

### <Thermal Shrinkage Rate>

The separator was cut into a square piece measuring 80 mm×80 mm as a sample. On a surface of the porous layer included in the sample, lines of a 60-mm square were drawn inside the outer edge of the 80-mm square. Thus, a measurement sample was obtained. The measurement sample was sandwiched between sheets of paper and placed in an oven heated to 150° C. One hour later, the measurement sample was removed from the oven. The length of a line drawn in the MD on the measurement sample was measured with use of a digital caliper. The length of the line drawn in the MD on the measurement sample which had been heated was regarded as D_{MD} (mm). With use of D_{MD}, a thermal shrinkage rate was calculated on the basis of Expression (5) below.

Thermal shrinkage rate[unit:%]={(60−D_{MD})/60}×100 (5):

### <Air Permeability>

The air permeability of the separator cut to a size of 60 mm×60 mm was measured in conformity with JIS P 8117 using a Gurley-type densometer G-B3C manufactured by Toyo Seiki Seisaku-sho, Ltd. The measured value was expressed in a Gurley value [unit: sec/100 cc]

### Synthesis Example 1

The resin A (poly(para-phenylene terephthalamide)) was synthesized by the following procedure. The resin A corresponds to the rigid resin.
1. A 0.5-L separable flask having a stirring blade, a thermometer, a nitrogen incurrent canal, and a powder addition port was sufficiently dried.
2. 408.6 g of NMP was introduced into the flask. Further, 31.4 g of calcium chloride (having been dried at 200° C. for 2 hours) was added, and a resulting mixture was heated to 100° C.
3. After the calcium chloride completely dissolved, the temperature of a resulting solution was returned to room temperature. Subsequently, 13.20 g of paraphenylenediamine was added and completely dissolved.
4. While the temperature of a resulting solution was maintained at 25±2° C., 24.24 g in total of terephthalic acid dichloride was added in 3 separate portions.
5. While the temperature of a resulting solution was maintained at 25±2° C., the solution was matured for 1 hour to obtain a solution that contained the resin A.

### Synthesis Example 2

The resin B (poly(4,4′-diphenylsulfonyl terephthalamide)) was synthesized by the following procedure. The resin B corresponds to the flexible resin.
1. A 0.5-L separable flask having a stirring blade, a thermometer, a nitrogen incurrent canal, and a powder addition port was sufficiently dried.
2. 415.5 g of NMP was introduced into the flask. Further, 31.9 g of calcium chloride (having been dried at 200° C. for 2 hours) was added, and a resulting mixture was heated to 100° C.
3. After the calcium chloride completely dissolved, 35.66 g of 4,4′-diaminodiphenylsulfone was added at 100° C. and completely dissolved.
4. A resulting solution was cooled to room temperature. While the temperature of the solution was maintained at 25±2° C., 22.45 g in total of terephthalic acid dichloride was added in 3 separate portions.
5. While the temperature of a resulting solution was maintained at 25±2° C., the solution was matured for 1 hour to obtain a solution that contained the resin B.

### Comparative Synthesis Example 1

The resin C (poly(4,4′-diphenylsulfonyl terephthalamide)) was synthesized by the following procedure.
1. A 0.5-L separable flask having a stirring blade, a thermometer, a nitrogen incurrent canal, and a powder addition port was sufficiently dried.
2. 408.6 g of NMP was introduced into the flask. Further, 31.4 g of calcium chloride (having been dried at 200° C. for 2 hours) was added, and a resulting mixture was heated to 100° C.
3. After the calcium chloride completely dissolved, 31.97 g of 4,4′-diaminodiphenylsulfone was added at 100° C. and completely dissolved.
4. A resulting solution was cooled to room temperature. While the temperature of the solution was maintained at 25±2° C., 25.88 g in total of terephthalic acid dichloride was added in 3 separate portions.
5. While the temperature of a resulting solution was maintained at 25±2° C., the solution was matured for 1 hour to obtain a solution that contained the resin C.

### Example 1

A porous layer that contained the resin A and the resin B at a weight ratio of 50:50 was produced. Specifically, the solutions obtained in Synthesis Examples 1 and 2 were mixed so that the weight ratio between the resin A and the resin B was 50:50. To 500 g of a resulting mixture (1), 11.68 g of calcium carbonate was added. A resulting solution was stirred for 10 minutes so as to be neutralized. Thus, a neutralized solution (1) was obtained. Subsequently, the neutralized solution (1) was diluted with NMP and defoamed under reduced pressure to prepare a coating solution (1) in slurry form. The coating solution (1) had a solid content concentration of 3% by weight. A ratio of a weight-average molecular weight of the resin A to a weight-average molecular weight of the resin B was 5.

Subsequently, a separator (1) was produced through the following procedure.
1. A porous polyethylene substrate (thickness: 11 μm) was unwound from a roll.
2. An impregnation roll was used to impregnate one side of the porous polyethylene substrate with NMP.
3. A bar coater was used to apply the coating solution (1) to the porous polyethylene substrate. In so doing, the amount of the coating solution (1) applied was adjusted so that a porous layer had a weight per unit area of 1.2 g/m². A surface to which the coating solution (1) was applied is different from the surface which was impregnated with NMP in step 2.
4. The porous polyethylene substrate to which the coating solution (1) was applied was introduced into a deposition tank set to 50° C. and a relative humidity of 70%, and was exposed to air having a temperature of 50° C. and containing water vapor with a relative humidity of 70%. Thus, a porous layer was deposited on the porous polyethylene substrate.
5. The porous polyethylene substrate with the porous layer deposited was cleaned with water and dried with hot air to remove moisture, so that the separator (1) was obtained. An air permeability of the separator (1) measured by the method described above was 163 s/100 mL.

### Example 2

Operations were carried out in the same manner as in Example 1 to obtain a separator (2), except that the solutions obtained in Synthesis Examples 1 and 2 were mixed so that the weight ratio between the resin A and the resin B was 60:40. An air permeability of the separator (2) measured by the method described above was 181 s/100 mL.

### Comparative Example 1

Operations were carried out in the same manner as in Example 1 to obtain a separator (3), except that the solution containing the resin C obtained in Comparative Synthesis Example 1 was used instead of the solution containing the resin B and that the amount of the coating solution applied was changed so that a porous layer had a weight per unit area of 1.3 g/m². An air permeability of the separator (3) measured by the method described above was 151 s/100 mL. A ratio of a weight-average molecular weight of the resin A to a weight-average molecular weight of the resin C was 2.1.

### Comparative Example 2

Operations were carried out in the same manner as in Example 2 to obtain a separator (4), except that the solution containing the resin C obtained in Comparative Synthesis Example 1 was used instead of the solution containing the resin B. An air permeability of the separator (4) measured by the method described above was 194 s/100 mL.

### Results

Evaluation results are shown in Table 1 below.

TABLE 1

| | Configuration and physical properties | | | | | | | | Evaluation results | |
|---|---|---|---|---|---|---|---|---|---|---|
| | Porous layer | | | | | | | | | Porous |
| | | | Weight | | | | | | Separator | layer |
| | | Content | per | | | | | | Thermal | Average |
| | | of resin | unit | Separator | | | | | shrinkage | pore |
| | Composition | A | area | Ta | Tb | Tc | Tb/ | Tc/ | rate | diameter |
| | of resins | [wt %] | [g/m²] | [N] | [N] | [N] | Ta | Ta | [%] | [nm] |
| Example 1 | Resin A + | 50 | 1.2 | 0.31 | 0.91 | 1.51 | 2.92 | 4.84 | 4.4 | 29.3 |
| | resin B | | | | | | | | | |
| Example 2 | Resin A + | 60 | 1.2 | 0.41 | 1.28 | 1.84 | 3.13 | 4.49 | 4.0 | 21.1 |
| | resin B | | | | | | | | | |
| Comp. | Resin A + | 50 | 1.3 | 0.06 | 0.54 | 1.01 | 9.05 | 16.94 | 32.6 | 29.3 |
| Example 1 | resin C | | | | | | | | | |
| Comp. | Resin A + | 60 | 1.2 | 0.03 | 0.32 | 0.95 | 10.9 | 32.60 | 25.2 | 22.3 |
| Example 2 | resin C | | | | | | | | | |

In each of the measurement of peel strength under heating conducted on the separators (1) to (4) obtained in Examples 1 and 2 and Comparative Examples 1 and 2, it was confirmed that the porous layer adhered to the peel tape after the test.

As indicated by the descriptions of Examples 1 and 2 and the information shown in Table 1, the separators (1) and (2) produced in Examples 1 and 2 correspond to the present separator and satisfy the requirement of satisfying Expression (1) and/or Expression (2) below.

$$Tb / Ta \leq 5. \qquad ( 1 )$$

$$Tc / Ta \leq 15. \qquad ( 2 )$$

However, as indicated by the descriptions of Comparative Examples 1 and 2 and the information shown in Table 1, the separators (3) and (4) produced in Comparative Examples 1 and 2 do not satisfy the requirement and therefore do not correspond to the present separator.

As shown in Table 1, the separators (1) and (2) exhibit a reduced thermal shrinkage rate and improved heat resistance compared to the separators (3) and (4).

Thus, it has been found that the present separator, by specifically satisfying the above requirement, achieves the effect of being further improved in heat resistance.

### INDUSTRIAL APPLICABILITY

An aspect of the present invention is applicable to an electrochemical device.

### REFERENCE SIGNS LIST

1: Porous layer
2: Interface
3: Elastic resistance
4: Viscous resistance
5: Elastic resistance
3′: Elastic resistance of broken porous layer
4′: Viscous resistance of broken porous layer
6: Porous substrate
7: Elastic resistance
8: Viscous resistance
9: Viscous resistance
7′: Elastic resistance of broken porous substrate
8′: Viscous resistance of broken porous substrate
9′: Viscous resistance
10: Model indicating an aspect of resistance in a laminated separator during a peel test
10′: Model indicating an aspect of resistance in a laminated separator in a state where a porous layer is broken after a peel test
11: Model indicating an aspect of resistance in a laminated separator during a peel test
11′: Model indicating an aspect of resistance in a laminated separator in a state where a porous substrate is broken after a peel test
12: Model indicating an aspect of resistance in a laminated separator during a peel test
12′: Model indicating an aspect of resistance in a laminated separator in a state where a porous layer is broken after a peel test

1. A separator for an electrochemical device, the separator comprising:
a porous substrate; and
a porous layer formed on at least one surface of the porous substrate,
the separator satisfying at least one of Expression (1) and Expression (2) below:
$$Tb / Ta \leq 5. \qquad ( 1 )$$
$$Tc / Ta \leq 15. \qquad ( 2 )$$
where Ta, Tb, and Tc represent respective peel strengths obtained as a result of performing peel tests on the separator under conditions of peel speeds of 1 mm/min, 100 mm/min, and 1000 mm/min, each of the peel tests being performed under a condition of a measurement temperature of 120° C. by a method in conformity with JIS K 6854-3.

2. The separator of claim 1, wherein Ta is not less than 0.10 N.

3. The separator of claim 1, wherein the porous layer contains one or more resins selected from the group consisting of a (meth)acrylate-based resin, a fluorine-containing resin, a polyester-based resin, a water-soluble polymer, and a nitrogen-containing aromatic resin.

4. The separator of claim 3, wherein the nitrogen-containing aromatic resin is an aramid resin.

5. The separator of claim 1, further comprising an adhesive layer separately from the porous substrate and the porous layer.

6. A material for an electrochemical device, the material comprising a positive electrode, a separator recited in claim 1, and a negative electrode, the positive electrode, the separator, and the negative electrode being arranged in this order.

7. An electrochemical device, comprising a separator recited in claim 1.

8. The electrochemical device of claim 7, wherein the electrochemical device is a secondary battery or a capacitor.
